(19) United States
(12) Patent Application Publication
(10) Pub. No.: US 2012/0110853 A1
(43) Pub. Date: May 10, 2012

(54) ROTARY ELECTRIC SHAVER AND MANUFACTURING METHOD OF OUTER CUTTER AND INNER CUTTER OF THE SAME

(75) Inventor: Yoshiyuki Mimura, Masumoto (JP)

(73) Assignee: IZUMI PRODUCTS COMPANY, Nagano (JP)

(21) Appl. No.: 13/290,570

(22) Filed: Nov. 7, 2011

(30) Foreign Application Priority Data
Nov. 8, 2010 (JP) 2010-249418

(51) Int. Cl. B26B 19/14; B23P 17/00; B23P 15/16

(52) U.S. Cl. 30/43.5; 29/896.6; 29/592

(57) ABSTRACT

A rotary electric shaver includes an outer cutter having an upper surface with annular shaving sections, formed with hair entry apertures, and an inner cutter having small blades, which rotate in sliding contact with the outer cutter from below the shaving sections. The outer cutter has a plurality of concentric annular shaving sections. The shaving section adjacent to an outer periphery is lower than the shaving section adjacent to a center. The shaving sections are formed on a plane horizontal to a central axis. This makes it possible to increase a shaving area, to precisely trace the curved surface of a concave portion of skin and to come in contact with the skin with a proper contact pressure, thus permitting smooth shaving of the concave portion. The shaver has a simple structure with a smaller number of components, featuring easier assembly and easier removal of hair bits.

### BACKGROUND OF THE INVENTION

1. Field of the Invention

The present invention relates to a rotary electric shaver and, more particularly, to a rotary electric shaver having an outer cutter which has annular shaving faces or sections with many hair entry apertures formed therein and an inner cutter having small blades which rotate in sliding contact with the outer cutter from below the shaving section. The present invention also relates to a manufacturing method of the outer cutter and the inner cutter used with the rotary electric shaver.

2. Description of the Related Art

This type of rotary electric shaver is required to be capable of enabling approximately disc-shaped outer cutters to minutely trace the fine irregularities in the skin surface to smoothly shave beard without leaving any unshaved places. For example, there is a problem in that chances of leaving unshaved areas tend to increase in a markedly uneven skin surface, such as an area below the jaw of a user or a wrinkled skin. As a solution to the problem, it is conveniently performed that the areas of the shaving faces or sections have been increased.

FIG. 6 illustrates two annular shaving sections concentrically formed to increase the shaving area so as to decrease the chances of leaving unshaved portions. Referring to FIG. 6, reference numeral 10 denotes an outer cutter and reference numeral 12 denotes an inner cutter. The upper surface (shaving section) of the outer cutter 10 has an annular outside shaving section 16 and an annular inner periphery (adjacent to the center) shaving section 18, which are concentrically formed around a central axis 20 (the rotational axis of the inner cutter 12), an annular groove 14 being provided therebetween. The inner cutter 12 has small blades 22 and 24, which are in sliding contact with the outer and the inner shaving sections 16 and 18 from below the lower surface thereof and which are integrally formed with the same metal sheet.

In the unit illustrated in FIG. 6, the inner and the outer shaving sections 16 and 18 are positioned on the same plane on which the central axis (the rotational axis) 20 is vertical (on a plane horizontal relative to the central axis 20) thereby to permit easy machining of the outer cutter 10 and the inner cutter 12. In this case, however, when shaving a portion where skin surface concavely curves, as with the portion below a jaw (reference numeral 26 in FIG. 6 denoting the skin curved surface under the jaw), the annular shaving section 18 adjacent to the center moves away from the skin surface, posing a problem in that the shaving area does not increase as expected.

To solve the aforesaid problem, according to the one illustrated in FIG. 7, an outer annular shaving section 16a and an inner periphery annular shaving section 18a adjacent to the center are bent into gently curved surfaces along a skin curved surface 26. In this case, however, the machining of the upper surface of an outer cutter 10a, i.e., the machining of the two annular shaving sections 16a and 18a, is complicated, and the tips (the top edges) of small blades 22a and 24a formed on the inner cutter 12a have to be curved accordingly. This poses a problem of poor machining efficiency with consequent lower productivity.

According to the rotary electric shaver illustrated in JP 2008-517696 (A) (corresponding to US 2009-025227A1 and WO 2006/048799), an outer cutter has three concentric annular shaving sections to provide a still larger shaving area than the one illustrated in FIG. 6 described above. However, the three shaving sections are positioned on the same plane, presenting the same problem as that illustrated in FIG. 6 (refer to FIG. 1 and paragraph [0018] (corresponding to paragraph 0021 of US 2009-025227A1)).

According to the outer cutters disclosed in JP 2008-99770 (A) (corresponding to U.S. Pat. No. 7,845,078B and EP 1914045A) and JP 2001-000755 (A) (corresponding to U.S. Pat. No. 6,460,252B and EP 1063033A1), an outer ring with an outer shaving section formed therein and an inner ring with an inner shaving section formed therein are provided separately, and the inner ring is engaged with the outer ring from below, allowing them to independently move in the vertical direction. The shaving section of each ring is set to be horizontal relative to the central axis so as to permit easy machining thereof.

As described above, the rotary electric shaver according to the JP 2008-517696 (A) provides a larger area of the shaving sections of the outer cutter, but the upper faces (the shaving section faces) of the outer cutters are on the same plane, so that the innermost or a middle shaving section cannot be brought into close contact with skin surface with a proper contact pressure, as with the example illustrated in FIG. 6, presenting the problem of an insufficiently increased substantial shaving area.

The rotary electric shavers according to the aforesaid JP 2008-99770 (A) and JP 2001-000755 (A) pose problems of complicated structures, a considerably large number of parts, and cumbersome assembly processes, resulting in low production efficiency. In addition, hair debris caught between parts are hard to remove, making the cleaning difficult.

### SUMMARY OF THE INVENTION

The present invention has been made with a view of the background described above, and it is a first object of the invention to provide a rotary electric shaver which is capable of increasing a shaving area, precisely tracing the curved surface of a concave portion of skin, and coming in contact with the skin with a proper contact pressure to smoothly shave the concave portion, which has a simple structure with a smaller number of components, and which permits easy assembling and also easy removal of hair bits.

A second object of the invention is to provide a manufacturing method of an outer cutter used with the electric shaver. Further, a third object of the invention is to provide a manufacturing method of an inner cutter used with the electric shaver.

According to the present invention, the first object is achieved by a rotary electric shaver including an outer cutter, an upper surface of which has annular shaving sections with a plurality of hair entry apertures formed therein, and an inner cutter having a small blade which rotates in sliding contact with the outer cutter from below the shaving section, wherein the outer cutter has a plurality of concentric annular shaving sections integrally formed, a shaving section adjacent to an outer periphery of the outer cutter is lower than a shaving section adjacent to a center of the outer cutter, and these shaving sections are formed on a plane horizontal relative to a central axis of the outer cutter.

The second object is achieved by a manufacturing method of an outer cutter used with the rotary electric shaver according to claim 1, including steps of:

concentrically forming a plurality of annular shaving sections and an annular groove positioned thereamong in a substantially disc-shaped metal material;

forming slits, which provide hair entry apertures, by a rotary disc-shaped grindstone, which rotates about a horizontal axis while moving across the annular shaving sections substantially in a radial direction, in a plurality of annular shaving sections at the same time;

grinding/abrading the upper surfaces of the plurality of the annular shaving sections by a grinding/abrasive tool which relatively rotates concentrically with a central axis and which has steps of different heights; and

grinding/abrading the lower surfaces of the plurality of annular shaving sections by a stepped grinding/abrasive tool which relatively rotates concentrically with the central axis.

The third object is fulfilled by a manufacturing method of an inner cutter used in the rotary electric shaver according to claim 1, wherein small blades which slidably contact with a plurality of annular shaving sections from below are integrally formed on a metal plate constituting an inner cutter, and the upper edges of the small blades are ground/abraded by a grinding/abrasive tool which relatively rotates concentrically with the central axis and which has steps, the heights of which vary toward the central axis.

According to the first aspect of the present invention, the plurality of concentric annular shaving sections or faces is formed on the upper surface of the outer cutter, so that the shaving area is increased to permit improved shaving efficiency. Further, the outer annular shaving section (adjacent to the outer periphery) is low, while the inner annular shaving section (adjacent to the center) is high. This allows all the annular shaving sections to precisely trace the curved surface of a concave portion of skin and to come in contact with the skin surface with an optimum contact pressure, thus making it possible to smoothly shave the concave portion.

A flat or convex portion of the skin can be smoothly shaved by applying mainly the inner annular shaving section thereto or tilting the entire electric shaver so as to tilt the upper surface (shaving section) thereof with respect to the skin. Further, the respective annular shaving sections are positioned on planes which are horizontal relative to the central axis and the heights of which differ toward the central axis. This simplifies the structures of the outer cutters and the inner cutters, reduces the number of components, and ensures easy assembling. Moreover, hair debris can be easily removed.

According to the second aspect of the present invention, the plurality of the annular shaving sections and the annular groove thereamong are formed in the metal sheet, which serves as the outer cutter, and the grinding/abrading tool with steps is relatively rotated concentrically with central axis of the outer cutter to grind/abrade the upper and lower surfaces of the outer cutter, thus making the machining easier.

According to the third aspect of the invention, the small blades that slidably contact with the plurality of annular shaving sections from below are integrally formed on the metal sheet constituting the inner cutter, and the upper edges of the small blades are ground/abraded by the grinding/abrasive tool which rotates concentrically with the central axis and which has steps having heights that differ toward the central axis. This permits easy machining of the inner cutter.

### BRIEF DESCRIPTION OF THE DRAWINGS

FIG. 1 is a perspective view illustrating the appearance of an embodiment of the present invention;

FIG. 2 is a sectional view of a cutter assembly as seen in FIG. 1;

FIG. 3 is an enlarged partial sectional view of an outer cutter according to the embodiment of the present invention, illustrating the machining method of slits;

FIG. 4 is a sectional view illustrating the grinding/abrading method of an outer cutter according to an embodiment of the present invention;

FIG. 5 is another sectional view illustrating the grinding/abrading method of an inner cutter according to an embodiment of the present invention;

FIG. 6 is a sectional view of a conventional cutter assembly; and

FIG. 7 is a sectional view of another conventional cutter assembly.

### DESCRIPTION OF THE PREFERRED EMBODIMENTS

The annular shaving sections in the outer cutter may be arranged in two concentric circles or three or more concentric circles. The hair entry apertures formed in the shaving sections of the outer cutter may be in the form of slits. The slits can be efficiently formed in all the shaving sections in a single step by moving a rotary disc grindstone, which rotates about a horizontal axis, in the radial direction thereof or by moving it while slightly tilting it in the radial direction (substantially in the radial direction) when machining the outer cutter, which will be discussed later.

In the inner cutter, the plurality of the small blades having different radii of rotation corresponding to all the annular shaving sections may be cut and raised to be integrally formed on the same metal plate, thus simplifying the structure of the inner cutter. In this case, as the rotary disc grindstone moves, the center of rotation thereof is moved vertically (in parallel to the central axis of the outer cutter) to form slits only in the annular shaving sections without cutting the annular groove. The annular groove is not to be cut, because it functions to support and reinforce adjoining annular shaving sections.

### First Embodiment

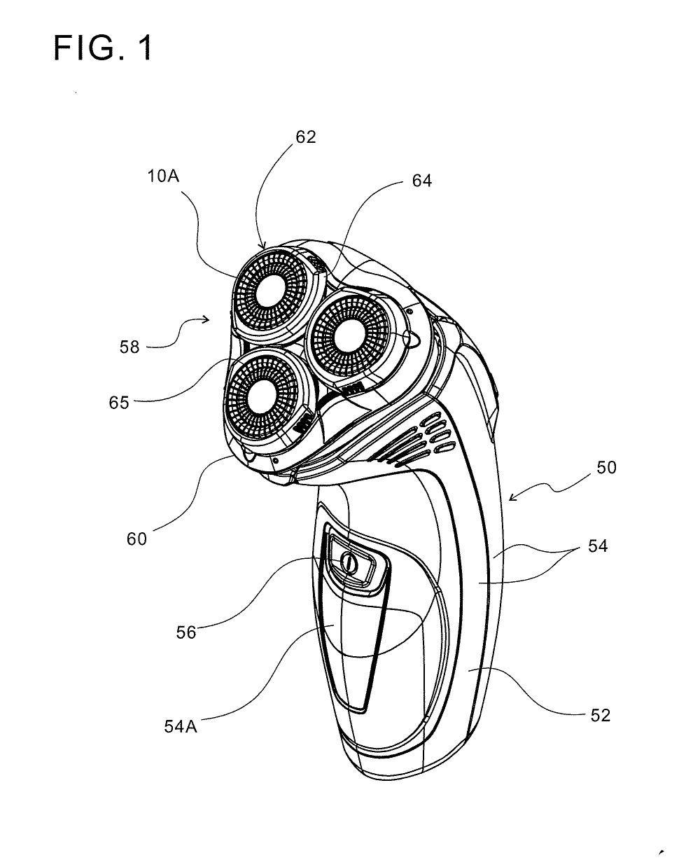

Referring to FIG. 1, a main body 50 has a case 54 formed by curving an upper portion of a grip 52, which is approximately columnar, diagonally upward to the front. The case 54, which can be split into a front counterpart and a back counterpart, houses a chargeable battery, an electric motor, a control circuit board and the like (not shown). A power switch 56 is attached to the front surface of the case 54. A display (not shown) composed of LED lamps indicating the amount of remaining charge of the battery, an operation status and the like is located under the switch 56. The display can be seen from outside through a translucent portion 54A of the case 54.

A head unit 58 is openably and detachably attached to an upper portion of the case 54. The head unit 58 is inclined relative to the grip 52 of the case 54 such that the shaving sections (the upper surface of a cutter frame 60, which will hereinafter be described in detail) are directed diagonally upward to the front. The electric motor has its rotation output shaft protruded from the upper surface of the case 54 into the head unit 58, rotatively drives an inner cutter 12A, which will be described hereinafter, and elastically pushes up the inner cutter 12A upward thereby to properly maintain the contact pressure of small blades 22A and 24A against the lower surfaces of shaving sections 16A and 18A.

The head unit 58 has a cutter frame 60 openably attached to the upper face of the case 54, and three sets of cutter assemblies 62 are installed to the cutter frame 60. The cutter frame 60 is approximately triangular in a planar view, the peripheral edge thereof being gently curved downwards. The cutter frame 60 has three circular mounting ports in which the cutter assemblies 62 are movably retained such that they may be tilted and also exhibit the habit of returning upwards.

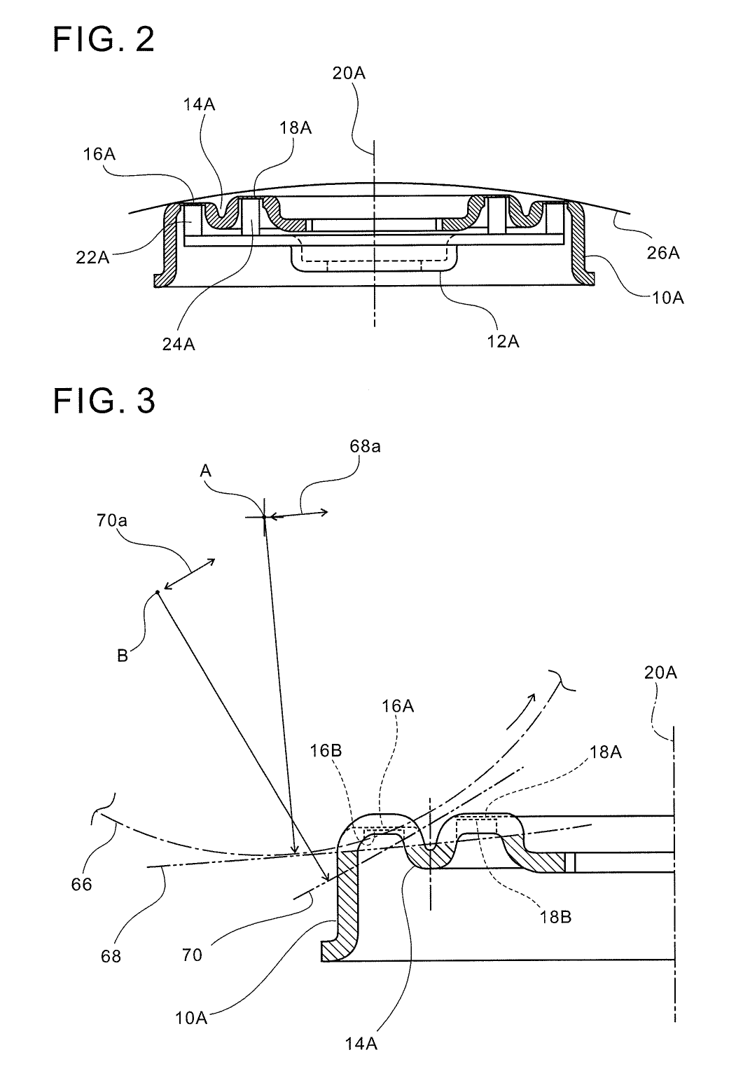

More specifically, each of the cutter assemblies 62 includes an outer cutter 10A which has a substantially discoid shape and the periphery of which is bent downwards, an outer cutter rim 64 in which the outer periphery of the outer cutter 10A is fitted (FIG. 1), and an inner cutter 12A which is in sliding contact with the outer cutter 10A from below (FIG. 2). The inner cutter 12A is rotatively retained on the cutter assembly 62 such that it does not come off downwards and is rotatively driven by the electric motor, as described above.

The upper surface of the outer cutter 10A has two annular shaving sections 16A and 18A formed concentrically with a central axis 20A, and an annular groove 14A formed therebetween, as illustrated in FIG. 2. Referring to the two annular shaving sections 16A and 18A, the inner shaving section 18A is above the level of the outer shaving section 16A along the central axis 20A, and these shaving sections 16A and 18A are positioned on horizontal planes orthogonal to the central axis 20A. In other words, these shaving sections 16A and 18A are positioned on horizontal planes which have different heights along the central axis 20A. Reference numeral 26A in FIG. 2 denotes a curved surface of skin which is concavely recessed.

As illustrated in FIG. 1, formed in the outer cutter 10A in the radial direction are many slits 65 which provide hair entry apertures, and the upper surface of the outer cutter 10A projects out beyond the outer cutter rim 64. The slits 65 are formed by a rotary disk grindstone 66, as illustrated in FIG. 3. More specifically, a metal sheet (metal material) that is to be turned into the outer cutter 10A is pressed to form the two shaving sections 16A and 18A and the annular groove 14A positioned therebetween, and then the rotary disk grindstone 66 cuts in the portions of the pressed metal material which are to be formed into the annular shaving sections 16A and 18A, from above, leaving the annular groove 14A intact. The rotary disk grindstone 66 is moved substantially in the radial direction while being rotated with the outer periphery thereof set vertically. The rotary disk grindstone 66 is a thin disc-shaped tool made by dispersing wear-resistant particles, such as diamond abrasive grains, in the abrasive grains, which are then hardened.

The rotary disk grindstone 66 first forms the two annular shaving sections 16A and 18A simultaneously to a depth along a first machining line 68 in FIG. 3. More specifically, a center of rotation A of the rotary disk grindstone 66 is moved substantially in the radial direction (in the direction of a movement line 68a in FIG. 3) such that the outer periphery (cutting edge) of the rotary disk grindstone 66 moves along a first machining line 68. To form only the slits 65 in the outer annular shaving section 16A selectively deeply, the center of rotation A is moved to position B so as to cause the outer periphery of the rotary disk grindstone 66 to move along a second machining line 70 shown in FIG. 3, and then the center B is moved substantially in the radial direction along a movement line 70a parallel to the second machining line 70.

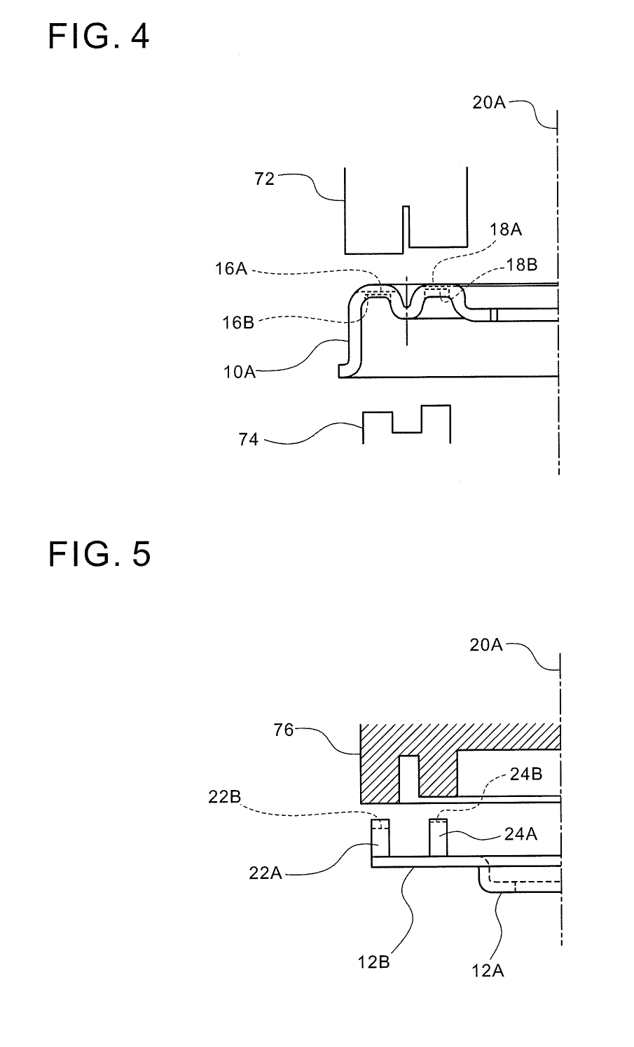

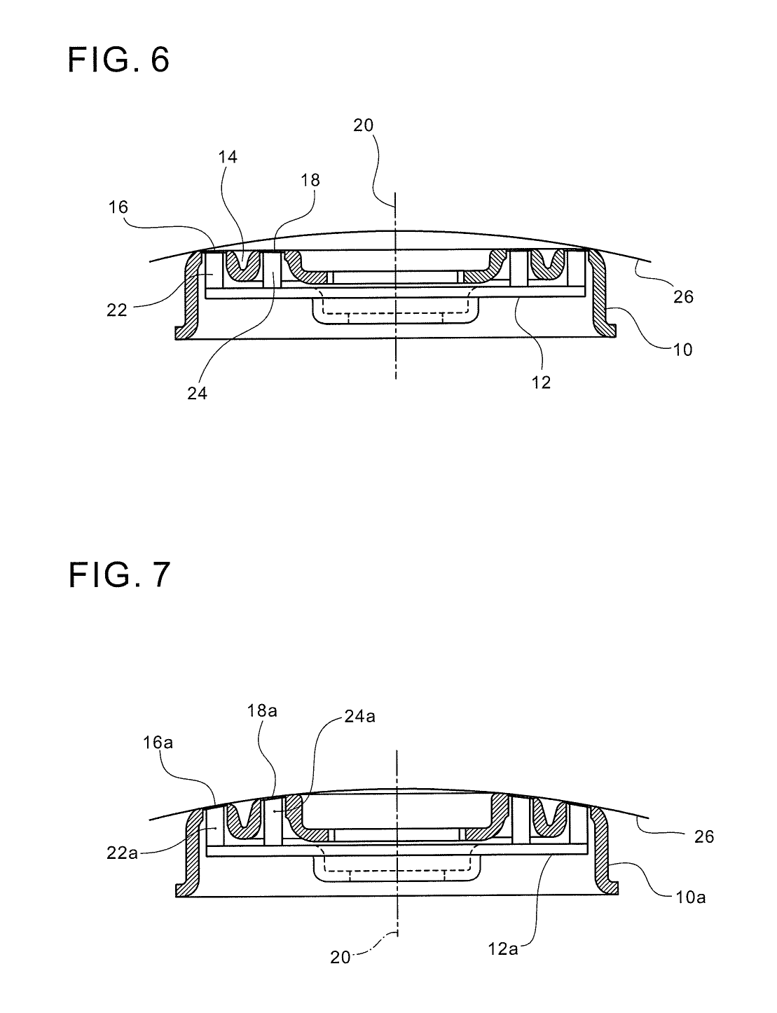

In this state, the portions which are to be formed into the annular shaving sections 16A and 18A have the thickness of the metal sheet of the outer cutter 10A, and will be machined to sufficiently thin annular shaving sections 16A and 18A by grinding the portions corresponding to the annular shaving sections 16A and 18A in the next step or by abrading the portions after the next step. The upper surfaces of the shaving sections 16A and 18A can be machined by rotating a grinding tool, such as a turning tool, or a abrasive tool (referring also to a grinding/abrasive tool to include both) 72, such as a grindstone, about the central axis 20A. The tool 72 has a step corresponding to the difference in height between the annular shaving sections 16A and 18A, thereby machining the upper surface, as illustrated in FIG. 4.

Further, the lower surfaces of the annular shaving sections 16A and 18A can be machined by rotating a grinding/abrading 74, which has a step corresponding to the difference in height therebetween, about the central axis 20A in the same manner as described above. Referring to FIG. 4, the dashed lines 16A and 18A denote the upper surfaces of the shaving sections (the surfaces to come in contact with skin) and the dashed lines 16B and 18B denote the lower surfaces of the shaving sections (the surfaces against which the small blades 22A and 24A of the inner cutter 12A slide, that is, the sliding surfaces of the inner cutter). It is needless to say that the outer cutter 10A may be rotated instead or together when the grinding/abrasive tool 72 or 74 is rotated.

Referring to FIG. 5, in the inner cutter 12A, the small blades 22A and 24A, which slidably contact with the lower surfaces (the inner cutter sliding surfaces) 16B and 18B of the shaving sections 16A and 18A, are integrally formed on a same metal plate 12B. The upper edges of the small blades 22A and 24A slidably contact with the lower surfaces 16B and 18B, which are the inner cutter sliding surfaces, to cut the hair that enters the slits 65. It is necessary, therefore, to match the heights of the upper edges with the heights of the inner cutter sliding surfaces 16B and 18B and also to abrade them so as to improve their sharpness. For this purpose, the metal plate 12B, which is to be formed into the inner cutter, can be machined by relatively rotating a grinding/abrasive tool 76, which has a step corresponding to the height difference, about the central axis 20A. Dashed lines 22B and 24B in FIG. 5 indicate the upper edges (blade surfaces) machined by the grinding/abrasive tool 76.

1. A rotary electric shaver, comprising:
an outer cutter, an upper surface of which has annular shaving sections with a plurality of hair entry apertures formed therein; and
an inner cutter having a small blade which rotates in sliding contact with a lower surface of the outer cutter from below the shaving sections,
wherein the outer cutter has a plurality of concentric annular shaving sections integrally formed, a shaving section adjacent to an outer periphery of the outer cutter is lower than a shaving section adjacent to a center of the outer cutter, and these shaving sections are formed on a plane horizontal to a central axis of the outer cutter.

2. The rotary electric shaver according to claim 1, wherein the outer cutter has two annular shaving sections, one of which is adjacent to an outer periphery and the other of which is adjacent to a center relative to a central axis.

3. The rotary electric shaver according to claim 1, wherein the hair entry apertures are formed to be slip-shaped in the annular shaving sections.

4. The rotary electric shaver according to claim 1, wherein the small blade which rotates in sliding contact with the plurality of the annular shaving sections from below is formed integrally with the inner cutter.

5. A manufacturing method of an outer cutter used with the rotary electric shaver according to claim 1, comprising steps of:
concentrically forming a plurality of annular shaving sections and an annular groove positioned thereamong in a substantially disc-shaped metal material;
forming slits, which provide hair entry apertures, by a rotary disc-shaped grindstone, which rotates about a horizontal axis while moving across the annular shaving sections substantially in a radial direction, in a plurality of annular shaving sections at the same time;
grinding/abrading the upper surfaces of the plurality of the annular shaving sections by a grinding/abrasive tool which relatively rotates concentrically with a central axis and which has steps of different heights; and
grinding/abrading the lower surfaces of the plurality of annular shaving sections by a stepped grinding/abrasive tool which relatively rotates concentrically with the central axis.

6. A manufacturing method of an inner cutter used in the rotary electric shaver according to claim 1, wherein small blades which slidably contact with a plurality of annular shaving sections from below are integrally formed on a metal plate constituting an inner cutter, and the upper edges of the small blades are ground/abraded by a grinding/abrasive tool which relatively rotates concentrically with the central axis and which has steps, the heights of which vary toward the central axis.
